(19) United States
(12) Patent Application Publication
(10) Pub. No.: US 2008/0254264 A1
(43) Pub. Date: Oct. 16, 2008

(54) TEXTILE SLEEVE FOR PROTECTING ELONGATE MEMBERS AND METHOD OF CONSTRUCTION

(76) Inventor: Hiroki Yamaguchi, Kanagawa (JP)

Correspondence Address: ROBERT L. STEARNS;Dickinson Wright PLLC, Ste. 2000, 38525 Woodward Avenue, Bloomfield Hills, MI, 48304-2970, US

(21) Appl. No.: 11/734,049

(22) Filed: Apr. 11, 2007

(51) Int. Cl. B32B 1/08; B32B 23/02

(52) U.S. Cl. 428/193; 264/632

(57) ABSTRACT

A textile sleeve for protecting elongate members and method of construction thereof provides a sleeve having a wall constructed at least in part from generally round monofilaments. The sleeve wall provides a central space extending along a longitudinal axis between opposite ends for receipt of the elongate members. The monofilaments have a region with a permanently melted and flattened outer surface adjacent at least one of the ends. The melted and flattened region provides an increased surface area to which tape can be adhered, while also acting to reduce the potential for end fray of the filaments forming the textile sleeve.

### BACKGROUND OF THE INVENTION

1. Field of the Invention

This invention relates generally to textile sleeves for protecting elongate members, and more particularly to textile sleeves having ends secured against relative axial movement to the elongate members.

2. Related Art

Protective sleeving is used throughout the automotive, industrial, marine, airline and aerospace industries to organize and protect elongate members, such as wiring harnesses and optical fiber cables, for example. The sleeving surrounds the elongate members and protects them against cuts, abrasion, radiant heat, vibration induced wear and other harsh environmental threats. When positioned within protective sleeving, the wiring or cables are also held together in a neat bundle, allowing a multiplicity of different items to be handled as a sub-assembly, thus saving time and effort during integration of the items into its end environment.

Protective sleeving may be made by weaving, braiding or knitting filaments into a textile substrate and then resiliently biasing the substrate into a tubular form to define a central space for receiving the elongate items. Biasing may be effected by heating the filaments when the substrate is wrapped about a cylindrical mandrel, wherein the filaments take on a permanent set conforming to the shape of the mandrel upon cooling. In addition, the filaments can also be resiliently biased into a curved shape by applying chemicals thereto, as well as by cold working.

When textile substrates are biased into a tubular shape via the mechanisms described above, monofilaments are typically oriented in the “hoop” or circumferential direction of the tube. Monofilaments provide excellent stiffness and provide strong resilient biasing that maintains the substrate in the tubular shape. The biased monofilaments also tend to restore the substrate to its tubular shape in the absence of a distorting force, which is generally applied when the sleeve is manipulated to an open state to insert or remove an elongate member.

In some applications, as shown in FIG. 5, upon a sleeve 110 having elongate members 122 disposed therein, it is necessary or desired to secure the sleeving 110 to the elongate member 122 to prevent relative axial movement between the elongate member 122 and the sleeving 110. Commonly, tape 124 is used to secure one or both ends of the sleeving 110 to the elongate member 122. The tape 124 is generally wrapped circumferentially about the assembly so that a portion of the tape 124 overlies and adheres to the end of the sleeving 110 while an opposite portion of the tape 124 overlies and adheres to the elongate member 122. Unfortunately, due to the sleeving being constructed at least in part from generally round monofilaments 130, the surface of the sleeving 110 to which the tape 124 is applied provides limited surface area for adhesion of the tape 124. The poor adhesion results largely due to the reduced surface area provided by the convex surfaces of the round filaments 130 forming the sleeving 110. As such, the tape 124 can become detached from the end of the sleeving 110, thus, allowing the sleeving 110 to move axially relative to the elongate member 122. This can result in unwanted exposure of the elongate member 122.

### SUMMARY OF THE INVENTION

The invention concerns a textile sleeve for protecting elongate members. The sleeve has a wall constructed at least in part from generally round monofilaments. The sleeve wall provides a central space extending along a longitudinal axis between opposite ends. The monofilaments having a region with a permanently melted and flattened outer surface adjacent at least one of the ends. The melted and flattened region provides an increased surface area to which tape can be adhered, while also acting to reduce the potential for end fray of the filaments forming the textile sleeve.

Another aspect of the invention includes a method of constructing a sleeve for protecting elongate members. The method includes interlacing filaments to form a textile substrate with at least some of said filaments being generally round monofilaments. Then, forming the substrate into a tubular shape having a central space extending along a longitudinal axis and plastically deforming a portion of the monofilaments to provide a flattened outer surface over a selected region of the substrate. Further, cutting the substrate into a desired length to form opposite ends of the sleeve with the flattened outer surface being adjacent at least one of the ends.

### BRIEF DESCRIPTION OF THE DRAWINGS

These and other aspects, features and advantages of the invention will become readily appreciated when considered in connection with the following detailed description of the presently preferred embodiments and best mode, appended claims and accompanying drawings, wherein:

FIG. 1 is a perspective view of a protective sleeve according to one presently preferred embodiment of the invention containing elongate members therein and being secured against relative axial movement to the elongate members;

FIG. 2 is schematic plan view of the protective sleeve shown in FIG. 1;

FIG. 3 is a cross-sectional view taken generally along the line 3-3 of FIG. 2 showing an end region of the sleeve with an adhesive tape applied thereto;

FIG. 4 is a cross-sectional view taken generally along the line 4-4 of FIG. 2 showing the end region and adhesive tape applied thereto; and

FIG. 5 is a fragmentary cross-sectional view of a textile sleeve with an adhesive layer applied thereto according to the prior art.

### DETAILED DESCRIPTION OF PRESENTLY PREFERRED EMBODIMENTS

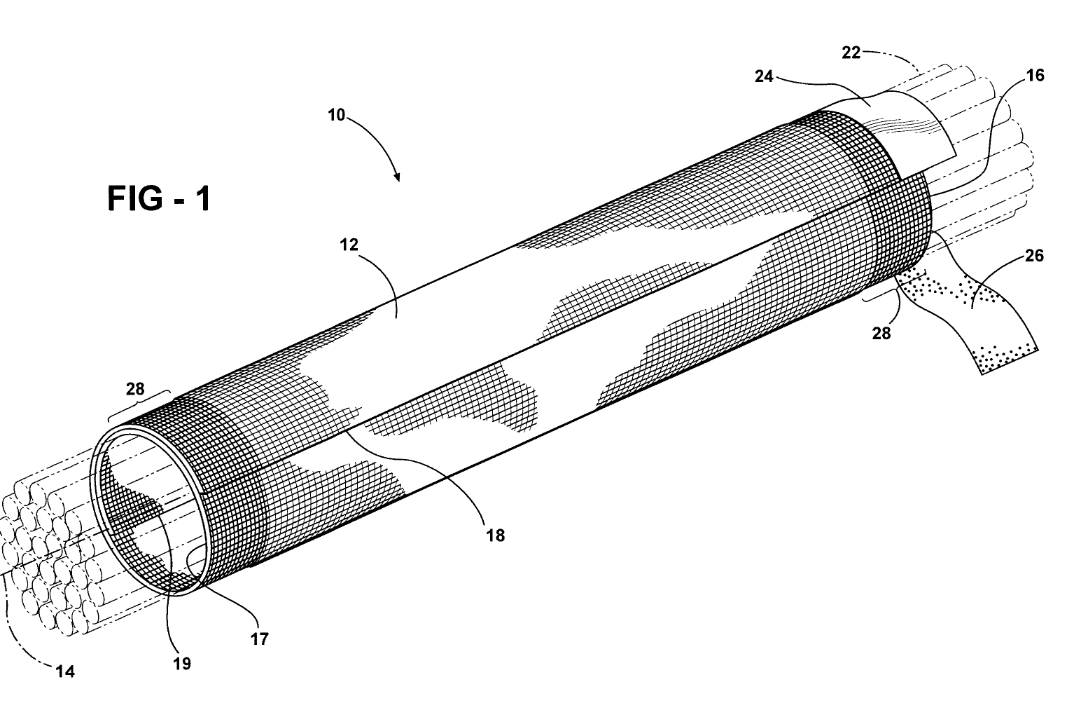

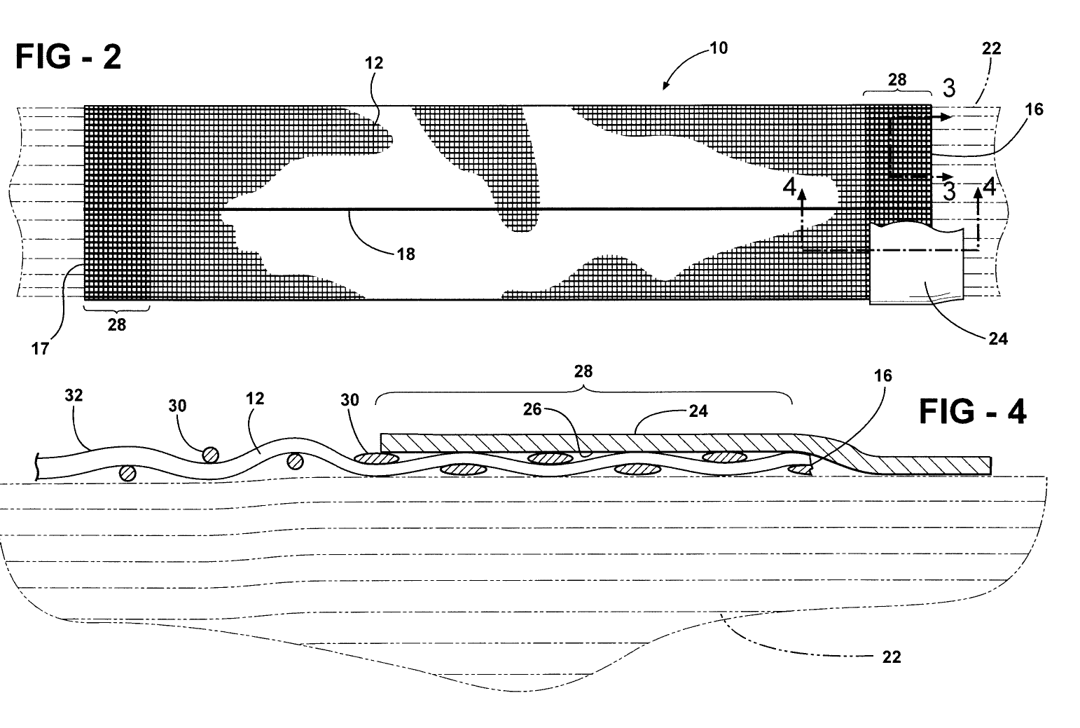

Referring in more detail to the drawings, FIGS. 1 and 2 illustrates a protective textile sleeve constructed in accordance with one presently preferred embodiment of the invention generally at 10. The sleeve 10 is constructed from an elongate textile substrate 12 that extends along a longitudinal axis 14 between opposite ends 16, 17. The substrate 12 can be knitted, braided, or woven, and has opposite selvages, referred to hereafter as free edges 18, 19 which either extend parallel to the axis 16 (the so-called “cigarette” wrap construction) or in a helical path (not shown) about the axis 16. In either case, the substrate 12 provides a central space 20 that receives elongate members 22 to be protected, such as a wiring harness or optical fibers, for example. The free edges 18 are generally unbound, and thus, can be opened or spread apart from one another to allow the elongate members 22 to be disposed or removed from the central space 20, as desired. Upon inserting the elongate members 22 into the space 20, the free edges 18, 19 can be curled in overlapping relation to one another so that the elongate members 22 are fully encapsulated about their circumference. It should be recognized that the substrate 12 can be provided as a self-curling substrate, such that the edges 18, 19 are self-biased in overlapping relation, or they could otherwise be curled through an externally applied force. Upon enclosing the elongate members 22 within the substrate 12, a tape 24 having an adhesive surface 26, such as a pressure sensitive adhesive, for example, can be applied to overlap one or both of the ends 14, 16 of the substrate with the tape also adhering to the elongate members 22 to prevent the sleeve 10 from moving axially relative to the elongate members 22. A region 28 of the substrate 12 adjacent the end or ends 16, 17 to which the tape 24 is applied is prepared, as discussed in more detail hereafter, to promote adhesion of the tape 24 thereto so that the tape 24 does not readily detach therefrom in use.

The substrate 12 has a plurality of interlaced yarn filaments, wherein at least some of the filaments are monofilaments 30, while others can be provided as multifilaments 32, if desired for the intended application. For example, the yarns 30, 32 could be, depending on the performance requirements of the application, formed from, by way of example and without limitations, polyester, nylon, polypropylene, and polyethylene. It is to be recognized that this is by no means a comprehensive list of possible materials, and that other materials, including fire retardant materials, could be used.

As shown here, for example, the substrate 12 is woven at least in part with generally round monofilaments 30 extending in a weft or fill direction that is generally perpendicular to the longitudinal axis 14 of the sleeve, while multifilaments 32 are woven along a warp direction generally parallel to the axis 14. However, the monofilaments 30 could be interlaced along the warp direction in combination with, or in place of the multifilaments 32. The monofilaments 30 provide rigidity and hoop strength to the sleeve 10, and also allow it to be biased, such as in a heat-setting process, into a self-curled tubular shape. The monofilaments 30 extend over the length of the sleeve 10, and have outer surfaces 34 exposed to an outer periphery 36 of the sleeve 10.

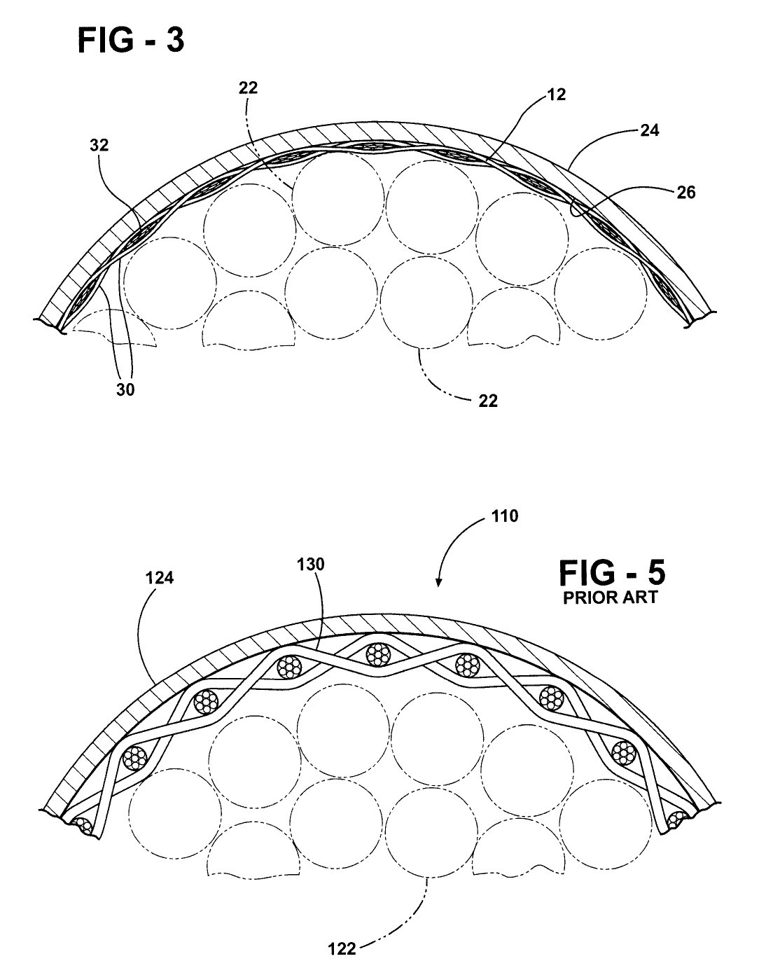

To facilitate bonding or adhering the tape 24 to the regions 28 adjacent the ends 16, 17 of the sleeve 10, the regions 28 are exposed to an ultrasonic welding process to flatten the outer surfaces 34 of the monofilaments 30 within the regions 28. The monofilaments 30 exposed to the ultrasonic welding are plastically deformed, and thus, at least partially melted so that the outer surfaces 34 flow to a permanently flattened configuration. As such, the outer surfaces 34 of the welded regions 28 remain substantially flattened, wherein the melted monofilaments 30 can flow at least partially over the multifilaments 32, if incorporated in the desired sleeve construction. The melted monofilament material flowing throughout the regions 28 provides a further function in addition to enhancing the adherence of the tape 24, in that it also acts to prevent a condition of end fray. End fray results, particularly with multifilaments, when the filaments adjacent the ends 16, 17 begin to unravel or separate from one another. With the melted material of the monofilaments 30 flowing throughout the regions 28, the potential for end fray is greatly reduced, and thus, the useful life of the sleeve 10 is increased. Accordingly, the melted regions 28 serve to provide an enhanced flattened surface area, as best shown in FIGS. 3 and 4, to which the adhesive surface 26 of the tape 24 can bond, while also reducing end fray from occurring. It should be recognized that the multifilaments 32 shown could be replaced with the monofilaments 30 so that the sleeve 10 would be fabricated entirely of monofilaments, if desired. Further, it should be recognized that the portions of the monofilaments 30 not exposed to the ultrasonic welding, such as between the regions 28, retain their generally round shape. Accordingly, the desired physical properties of the non-welded monofilament portions, such as strength, rigidity and resistance to abrasion, for example, are not altered.

In manufacture, the yarns of the substrate 12 are interlaced together, whether being woven, braided or knitted. As shown here, wherein the sleeve 10 is an open construction with opposite edges extending along the length of the sleeve, the substrate can be formed as a generally flat fabric, and then shaped, such as in a heat-setting process about a mandrel to take on its tubular shape. Upon being heat-set into the tubular shape, the overlapped edges 18, 19 are preferably opened slightly and out of contact with one another, and then the regions 28 extending at least partially, and preferably completely across the width between the edges 18, 19 of the substrate 12 are exposed to the ultrasonic welding process to form the substantially flattened outer surfaces adjacent the ends 16, 17. Then, while still in the slightly opened state, the desired segment length of the sleeve is cut in a cutting operation, such as a hot-cutting process. By performing the ultrasonic welding and cutting operations with the substrate 12 in a partially opened configuration, the end regions 28 are prevented from being bonded in a permanently closed configuration. It should be understood that the desired length segments for the sleeve 10 could be cut first, and then the selected regions 18 could be ultrasonically welded, if desired.

The weld pressure, weld time and power settings used in the ultrasonic welding process will vary depending on the type and size of monofilament yarn used to construct the sleeve, as well as the size of the sleeve itself. It is important to recognize that the desired settings should avoid forming holes in the substrate 12, while being sufficient to provide the permanently flattened regions 28 to increase the adherence, and thus, peel strength of the tape 24 from the end regions 28 of the sleeve 10 once applied.

Obviously, many modifications and variations of the present invention are foreseeable in light of the above teachings. It is, therefore, to be understood that within the scope of the appended claims, the invention may be practiced otherwise than as specifically described for the presently preferred embodiments.

What is claimed is:

1. A textile sleeve for protecting elongate members, comprising:
a substrate constructed at least in part from generally round monofilaments, said substrate providing a central space extending along a longitudinal axis between opposite ends; and
said monofilaments having a region extending along said axis with a permanently flattened outer surface adjacent at least one of said ends.

2. The textile sleeve of claim 1 wherein said permanently flattened outer surface extends circumferentially about said substrate.

3. The textile sleeve of claim 1 wherein at least some of said monofilaments are woven in a fill direction generally perpendicular to said longitudinal axis.

4. The textile sleeve of claim 3 further comprising multifilaments woven in a warp direction generally parallel to said longitudinal axis.

5. The textile sleeve of claim 1 where is said sleeve has opposite free edges extending along said longitudinal axis.

6. The textile sleeve of claim 5 wherein said free edges are biased in overlapping relation to one another.

7. The textile sleeve of claim 1 wherein said region with a permanently flattened outer surface is adjacent both of said ends.

8. The textile sleeve of claim 7 wherein said monofilaments remain generally round between said regions.

9. The textile sleeve of claim 1 wherein said portion is plastically deformed.

10. A method of constructing a sleeve for protecting elongate members, comprising:
interlacing filaments to form a textile substrate with at least some of said filaments being round monofilaments;
forming said substrate into a tubular shape having a central space extending along a longitudinal axis;
plastically deforming a portion of said monofilaments to provide a flattened outer surface over a selected region of said substrate; and
cutting said substrate into a desired length to form opposite ends of said sleeve with said flattened outer surface being adjacent one of said ends.

11. The method of claim 10 wherein said plastically deforming step includes ultrasonically welding said monofilaments.

12. The method of claim 10 wherein said plastically deforming step includes flattening the outer surfaces on said monofilaments over selected regions adjacent both of said ends.

13. The method of claim 10 wherein said interlacing step is performed by weaving.

14. The method of claim 13 further weaving said monofilaments in a fill direction generally perpendicular to said longitudinal axis.

15. The method of claim 10 wherein said forming step includes biasing said fabric into said tubular wall in a heat-setting process.

16. The method of claim 15 further including forming said tubular wall having overlapping edges extending along said longitudinal axis.

17. The method of claim 16 further including spreading said overlapping edges out of engagement with one another prior to said plastically deforming step.

18. The method of claim 16 further including spreading said overlapping edges out of engagement with one another prior to said cutting step.
